(19) United States
(12) Patent Application Publication
(10) Pub. No.: US 2019/0208782 A1
(43) Pub. Date: Jul. 11, 2019

(54) PROCESSING COMPOSITION FOR CONTROLLING AQUATIC WEEDS

(71) Applicant: Arch Chemicals, Inc., Morristown, NJ (US)

(72) Inventors: Ryan M. Wersal, Eagle Lake, MN (US); Brian Sook, Gainesville, GA (US)

(21) Appl. No.: 16/239,754

(22) Filed: Jan. 4, 2019

Related U.S. Application Data
(60) Provisional application No. 62/613,847, filed on Jan. 5, 2018.

(51) Int. Cl. A01N 43/40; A01N 25/04; A01N 25/30

(52) U.S. Cl. CPC A01N 43/40; A01N 31/14; A01N 25/30; A01N 25/04

(57) ABSTRACT

A method for controlling aquatic weeds as disclosed. The method includes treating a body of water, such as a lake, with a fluroxypyr derivative herbicide. The fluroxypyr derivative herbicide may be a fluroxypyr ester or a fluroxypyr salt.

### RELATED APPLICATION

The present application is based on and claims priority to U.S. Provisional Patent application Ser. No. 62/613,847 filed on Jan. 5, 2018, which is incorporated herein by reference.

### BACKGROUND

Many different pesticides, such as herbicides, are commercially available for controlling unwanted plant populations. The herbicides are designed to limit growth and/or destroy a particular plant or a broad range of plants. The herbicide may function in different ways. For instance, some herbicides inhibit plant growth by inhibiting photosynthesis. Other herbicides are designed to be taken in by the plant for inhibiting enzyme production. Other herbicides may work as an oxidizer or may regulate plant growth by serving as an auxin mimic.

Of particular importance is that the herbicide be capable of controlling growth or destroying a plant population without harming the environment. For example, ideally a herbicide will control plant growth without having significant long-term adverse impacts on non-target organisms in the environment.

Particular problems are faced when attempting to control plant growth in an aquatic environment, particularly in areas of high water exchange. Under these circumstances, the application of the herbicide may not result in a high enough concentration to control the target organism. Given the use sites for aquatic herbicides, a margin of safety for non-target organisms should be met, and therefore very small amounts of herbicides are typically permitted for use in aquatic environments. These low concentrations, however, may not be sufficient to control a particular plant population, given environmental conditions as those described above.

Another particular problem that can arise especially when attempting to control plant growth in aquatic environments is that the aquatic plant can become resistant to herbicides over time especially when the herbicides are applied at relatively low concentrations. For example, 2,4-D (dichlorophenoxyacetic acid) has been used successfully to control various aquatic weeds for many years. 2,4-D, for instance, has been the industry standard for controlling Eurasian Watermilfoil. Even though 2,4-D has a complex mode of action, repeated use over the same plant population may result in the development of resistance in target plants.

Thus, a need exists for an aquatic herbicide that can be used to replace 2,4-D or used in rotation with 2,4-D. A need also exists for an alternative aquatic herbicide capable of controlling the growth of aquatic weeds at very low concentrations and without detrimentally affecting the health of other native plant life within the body of water.

### SUMMARY

In general, the present disclosure is directed to an aquatic herbicide composition that is capable of controlling aquatic weeds in a body of water. Of particular advantage, the aquatic herbicide composition is effective at relatively low concentrations. The aquatic herbicide composition is particularly well-suited for treating bodies of water, and particularly quiescent bodies of water. Bodies of water that can be treated in accordance with the present disclosure include, for instance, ponds, lakes including reservoirs, swamps, and the like. As used herein, a “quiescent body of water” refers to any of the above described bodies of water such as lakes and ponds and excludes terranean crop fields including rice fields.

In one embodiment, the present disclosure is directed to a method for selectively controlling aquatic weeds. The term “selectively” indicates that aquatic weeds are killed or are prevented from growing without also harming many of the other plants in the aquatic environment. In accordance with the present disclosure, the method includes applying to a body of water an aquatic herbicide composition in a herbicidally effective amount sufficient to kill a submersed, floating or emergent aquatic weed. The aquatic herbicide comprises a fluroxypyr herbicide. The fluroxypyr herbicide comprises a fluroxypyr ester, fluroxypyr salt, or mixtures thereof.

In one particular embodiment, for instance, the fluroxypyr herbicide is the fluroxypyr ester. The fluroxypyr ester, for instance, may comprise a meptyl ester or a butomeptyl ester. Alternatively, the fluroxypyr herbicide may comprise the fluroxypyr salt. The fluroxypyr salt, for instance, may comprise a alkali metal salt or an alkaline earth metal salt. For example, the herbicide may comprise a potassium salt, a sodium salt, a magnesium salt, a calcium salt, a barium salt, or mixtures of thereof.

The aquatic herbicide composition of the present disclosure is particularly well suited for killing, destroying or otherwise controlling the growth of various aquatic weeds. In one embodiment, for instance, the aquatic herbicide composition is applied to the body of water in an amount sufficient to kill a milfoil, such as Eurasian watermilfoil. In an alternative embodiment, the aquatic herbicide composition can be applied to the body of water in an amount sufficient to kill or destroy a water hyacinth.

The aquatic herbicide composition can contain the fluroxypyr herbicide alone or in combination with various other components. In one embodiment, for instance, the aquatic herbicide composition contains water alone or in combination with a surfactant. The surfactant may comprise, for instance, an ethoxylated surfactant. In one embodiment, for instance, the surfactant may comprise an ethoxylated castor oil, an ethoxylated tridecyl alcohol, an ethoxylated tristyryl phenol, an ethoxylated fatty acid, or mixtures thereof. When formulated in a liquid form, the aquatic herbicide composition can contain the fluroxypyr herbicide in an amount from about 10% to about 70% by weight, such as in an amount from about 15% to about 50% by weight, such as in an amount from about 20% to about 35% by weight. In another embodiment, the aquatic herbicide composition may be formulated in a dry form.

Of particular advantage, the aquatic herbicide composition can be applied to a body of water at relatively low concentrations and still be very effective at controlling aquatic weeds. For example, in one embodiment, the aquatic herbicide composition can be applied to the body of water such that the fluroxypyr herbicide is present in the body of water at a concentration of less than about 4000 ppb, such as less than about 3500 ppb, such as less than about 2000 ppb, such as less than 1000 ppb, such as less than about 800 ppb, such as less than about 600 ppb, such as less than about 400 ppb, such as less than about 300 ppb, such as less than about 200 ppb. The fluroxypyr herbicide is generally present in the body of water at a concentration of greater than about 10 ppb, such as greater than about 20 ppb. The aquatic herbicide composition of the present disclosure is very effective at controlling aquatic weeds without having to combine the fluroxypyr herbicide with other herbicides. For instance, in one embodiment, the fluroxypyr herbicide is the only herbicide present in the aquatic herbicide composition.

Various different techniques can be used to apply the aquatic herbicide composition to a body of water. In one embodiment, for instance, the aquatic herbicide composition can be sprayed onto the body of water. In an alternative embodiment, the aquatic herbicide composition can be pumped into the body of water below the surface of the water.

In one embodiment, the aquatic herbicide composition can be sprayed over plant foliage on a body of water. When sprayed over the surface of the water, for instance, in one embodiment, the dosage level applied to a body of water is less than about 30 oz. of the fluroxypyr herbicide per acre, such as less than about 20 oz. per acre, such as less than about 10 oz. per acre, such as less than about 8 oz. per acre, such as less than about 4 oz. per acre, such as less than about 1 oz. per acre. The fluroxypyr herbicide is generally applied at a rate greater than about 0.01 oz. per acre, such as greater than about 1 oz. per acre. As used herein, “an acre” of a body of water is measured by the surface area of the aquatic plant mat.

Other features and aspects of the present disclosure are discussed in greater detail below.

### BRIEF DESCRIPTION OF THE DRAWINGS

FIGS. 1 through 9 are a graphical representation of some of the results obtained in the examples below.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to a method for controlling aquatic weeds. In accordance with the present disclosure, the method includes treating a body of water with a herbicidally effective amount of an aquatic herbicide composition sufficient to kill at least one submersed, floating, or emergent aquatic weed without otherwise adversely harming the environment and other plants. Of particular advantage, the aquatic herbicide composition of the present disclosure can be administered at extremely low dosages and be very effective in killing, destroying or controlling the growth of a target aquatic weed. In accordance with the present disclosure, the aquatic herbicide composition contains a fluroxypyr herbicide, particularly a fluroxypyr ester or a fluroxypyr salt. The fluroxypyr herbicide, for instance, can be water soluble when applied to the body of water.

Many aquatic weeds, such as many milfoil genotypes, continue to spread across the United States and across various other geographical territories. For example, Eurasian watermilfoil and the floating weed Water hyacinth are rapidly growing and spreading aquatic weeds that can very quickly damage aquatic environments. Conventionally, the herbicide, 2,4-D has been the primary herbicide to control many aquatic weeds, especially Eurasian watermilfoil. Although 2,4-D is a very effective herbicide that can kill aquatic weeds without harming other plants in the environment, unfortunately, few other effective alternatives exist. Repeated and continued use of 2,4-D may result in resistance development in aquatic weeds. Thus, effective alternatives to 2,4-D are needed that can be used alone or in conjunction with 2,4-D.

The present disclosure is directed to an aquatic herbicide that can be just as effective as 2,4-D made from a fluroxypyr derivative. The fluroxypyr derivative, for instance, can be formulated so as to be water soluble when administered to a body of water. Once absorbed by an aquatic weed or otherwise contacted with an aquatic weed, the fluroxypyr derivative can convert into the acid species that can effectively kill the aquatic weed. Fluroxypyr is a synthetic auxin and can be classified as a pyridine carboxylic acid. Of particular advantage, it was discovered that the fluroxypyr herbicide of the present disclosure can be very effective against many aquatic weeds, such as Eurasian watermilfoil, at use rates or at concentrations even lower than that used conventionally for the herbicide

As used herein, fluroxypyr refers to [(4-amino-3,5-dichloro-6-fluoro-pyridinyl)oxy] acetic acid. Fluroxypyr, however, is an acid that has poor water solubility and dispersibility characteristics. Thus, in one embodiment of the present disclosure, the fluroxypyr herbicide used in the aquatic herbicide composition comprises a fluroxypyr derivative that has greater water solubility than fluroxypyr. The fluroxypyr derivative, for instance, may comprise a fluroxypyr ester or a fluroxypyr salt. In one embodiment, for instance, the fluroxypyr herbicide comprises a meptyl ester of fluroxypyr or a buto meptyl ester of fluroxypyr. For example, in one embodiment, the fluroxypyr ester comprises [(4-amino-3,5-dichloro-6-fluoro-2-pyridinyl)oxy]acetic acid, 1-methylheptyl ester.

In addition to a fluroxypyr ester, the fluroxypyr herbicide of the present disclosure may also comprise a fluroxypyr salt. For example, in one embodiment, the fluroxypyr herbicide comprises a water soluble salt of fluroxypyr. For example, in one embodiment, the fluroxypyr herbicide comprises an alkali metal, an alkaline earth metal, or an ammonium salt of fluroxypyr. For example the herbicide may comprise a potassium salt, a sodium salt, a magnesium salt, a calcium salt, or a barium salt of fluroxypyr.

In accordance with the present disclosure, the fluroxypyr herbicide as described above is formulated into a herbicide composition for application to bodies of water in order to control aquatic weeds. The herbicide composition is applied to the body of water in a herbicidally effective amount sufficient to kill a targeted aquatic weed. As used herein, a herbicidally effective amount is an amount of the fluroxypyr herbicide which causes an adversely modifying effect to the plant. For instance, the effect is a deviation from natural development and can include killing the plant, regulation of the growth of the plant, desiccation of the plant, retardation of the plant species, or the like.

The aquatic herbicide composition of the present disclosure containing the fluroxypyr herbicide is effective at killing or otherwise controlling the growth of many aquatic plants. As described above, the herbicide composition is also selective such that the composition is capable of destroying or retarding the growth of weeds while not harming other plant species. The target aquatic weed, for instance, may comprise a floating aquatic weed, a submersed aquatic weed or an emergent aquatic weed. Aquatic weeds that can be controlled in accordance with the present disclosure include floating and/or emergent dicotyledon species and various selected monocotyledon species.

Floating aquatic weeds that may be controlled in accordance with the present disclosure include, for instance, water hyacinth, water primrose and/or alligatorweed Water hyacinth may be considered one of the most invasive aquatic weeds. Water hyacinth is a free-floating plant that originates from the tropical and subtropical regions of South America. Water hyacinth can rapidly reproduce doubling the number of plants in less than two weeks and increasing in dry biomass at a rate of 1,2% per day. Water hyacinth, for instance, can cause various problems in bodies of water including impeding water flow, navigation, recreation, hydro-power generation, and the like. The floating plant can also clog potable water dams. Of particular advantage, the herbicidal composition of the present disclosure has been found well suited for controlling the growth of water hyacinths.

In addition to floating plants, the herbicide composition of the present disclosure is also well suited for selectively controlling the growth of submerged plants. Submerged plants that may be killed or controlled in accordance with the present disclosure include milfoil and the like. For example, the herbicide composition of the present disclosure is particularly well suited to killing or otherwise controlling the growth of Eurasian watermilfoil in bodies of water.

Emergent aquatic weeds that may be controlled in accordance with the present disclosure include various dicotyledon species.

Although the aquatic herbicide composition of the present disclosure is well suited to controlling the growth of any of the plants listed above, the aquatic herbicide composition has also been found to be selective in its modes of action thereby having little or no effect on other plant species within the environment. For instance, many monocotyledon plants have been shown to have tolerance to the aquatic herbicide composition of the present disclosure. For instance, the aquatic herbicide composition at certain concentrations can target an aquatic weed while having little to no impact on pondweeds such as sago pondweed.

Various different types of bodies of water can be treated in accordance with the present disclosure. In one embodiment, for instance, the body of water may comprise a quiescent body of water. Particular bodies of water well suited for application of the aquatic herbicide include fresh bodies of water such as lakes, ponds, wetlands, reservoirs, irrigation panels, and the like. In other embodiments, the body of water being treated in accordance with the present disclosure may comprise a river, stream, creek, or the like.

The aquatic herbicide composition of the present disclosure that contains the fluroxypyr herbicide can be formulated in a dry form or in a liquid form. Liquid formulations can include emulsions, suspensions, solutions, and dispersions. In addition to the fluroxypyr herbicide, the aquatic herbicide composition can contain various other additives and components. Other additives that may be present include, for instance, solvents, wetting agents, suspending agents, anti-caking agents, dispersing agents, emulsifiers, antifreeze agents, antifoam agents, surfactants, and the like.

In one embodiment, the herbicide composition can be formulated in liquid form and can be in the form of a solution or an emulsion that does not contain any solid matter. In one embodiment, for instance, the aquatic herbicide composition may comprise an aqueous solution containing the fluroxypyr herbicide. Water, for instance, can be present in the aquatic herbicide composition in an amount greater than about 10% by weight, such as in an amount greater than about 15% by weight, such as in an amount greater than about 20% by weight, such as in an amount greater than about 25% by weight, such as in an amount greater than about 30% by weight, such as in an amount greater than about 35% by weight, such as in an amount greater than about 40% by weight, such as in an amount greater than about 45% b weight, such as in an amount greater than about 50% by weight, such as in an amount greater than about 55% by weight, such as in an amount greater than about 60% by weight, such as in an amount greater than about 65% by weight. Water can be contained in the aquatic herbicide composition generally in an amount less than about 95% by weight, such as in an amount less than about 90% by weight, such as in an amount less than about 85% by weight, such as in an amount less than about 80% by weight, such as in an amount less than about 75% by weight, such as in an amount less than about 70% by weight, such as in an amount less than about 65% by weight.

One or more fluroxypyr herbicides in accordance with the present disclosure, such as one or more fluroxypyr esters and/or fluroxypyr salts, can be present in the aquatic herbicide composition generally in an amount greater than about 10% by weight, such as greater than about 15% by weight, such as in an amount greater than about 20% by weight, such as in an amount greater than about 25% by weight, such as in an amount greater than about 30% by weight, such as in an amount greater than about 35% by weight. One or more fluroxypyr herbicides are generally present in the composition in an amount less than about 70% by weight, such as in an amount less than about 60% by weight, such as in an amount less than about 50% by weight, such as in an amount less than about 45% by weight, such as in an amount less than about 40% by weight, such as in an amount less than about 35% by weight.

In one embodiment, the aquatic herbicide composition (whether in liquid or in dry form) can contain one or more surfactants. Surfactants that are useful in the compositions described herein may be either non-ionic, anionic, amphoteric or cationic, or a combination of any of the above, depending on the application. Suitable non-ionic surfactants include alkanolamides, amine oxides, block polymers, ethoxylated primary and secondary alcohols, ethoxylated alkylphenols, ethoxylated fatty esters, sorbitan derivatives, glycerol esters, propoxylated and ethoxylated fatty acids, alcohols, and alkyl phenols, alkyl glucoside glycol esters, polymeric polysaccharides, sulfates and sulfonates of ethoxylated alkylphenols, and polymeric surfactants. Suitable anionic surfactants include ethoxylated amines and/or amides, sulfosuccinates and derivatives, sulfates of ethoxylated alcohols, sulfates of alcohols, sulfonates and sulfonic acid derivatives, phosphate esters, and polymeric surfactants. Suitable amphoteric surfactants include betaine derivatives. Suitable cationic surfactants include amine surfactants. Those skilled in the art will recognize that other and further surfactants are potentially useful in the compositions depending on the particular application. For example, a blend of non-ionic and anionic surfactants may be used.

Preferred anionic surfactants used in the composition include CalFoam™ ES 603, a sodium alcohol ether sulfate surfactant manufactured by Pilot Chemicals Co., and Steol™ CS 460, a sodium salt of an alkyl ether sulfate manufactured by Stepan Company. Preferred non-ionic surfactants used in the enzyme/surfactant compound include Neodol™ 25-7 or Neodol™ 25-9, which are C12-C15 linear primary alcohol ethoxylates manufactured by Shell Chemical Co., and Genapol™ 26 L-60 which is a C12-C16 natural linear alcohol ethoxylated to 60E C cloud point (approx. 7.3 mol), manufactured by Hoechst Celanese Corp.

In one particular embodiment, the aquatic herbicide composition can comprise an aqueous composition containing one or more alkoxylated surfactants. Surfactants well suited for use in the composition include, for instance, ethoxylated castor oil, ethoxylated tridecyl alcohol, ethoxylated tristyryl phenol, an ethoxylated fatty acid, or mixtures thereof. The surfactant, for instance, may contain greater than about 10 mols of ethoxylate, such as greater than about 20 mols of ethoxylate, such as greater than about 30 mols of ethoxylate, such as greater than about 40 mols of ethoxylate, such as greater than about 50 mols of ethoxylate, and generally less than about 100 mols of ethoxylate, such as less than about 80 mols of ethoxylate, such as less than about 70 mols of ethoxylate.

In general, one or more surfactants can be present in the aquatic herbicide composition in an amount greater than about 0.1% by weight, such as in an amount greater than about 0.5% by weight, such as in an amount greater than about 0.7% by weight, such as in an amount greater than about 1% by weight, such as in an amount greater than about 1.5% by weight, such as in an amount greater than about 2% by weight, such as in an amount greater than about 3% by weight, such as in an amount greater than about 4% by weight, such as in an amount greater than about 5% by weight. The one or more surfactants can be present in the aquatic herbicide composition generally in an amount less than about 50% by weight, such as in an amount less than about 40% by weight, such as in an amount less than about 30% by weight, such as in an amount less than about 20% by weight, such as in an amount less than about 15% by weight, such as in an amount less than about 10% by weight, such as in an amount less than about 8% by weight, such as in an amount less than about 5% by weight, such as in an amount less than about 3% by weight.

As described above, the aquatic herbicide composition of the present disclosure can be applied to bodies of water at surprising low concentrations while still being very effective against many aquatic weeds. For example, the aquatic herbicide composition can be applied to a body of water such that one or more fluroxypyr herbicides present in the composition are added to the body of water at a concentration of less than about 10,000 ppb, such as less than about 5,000 ppb, such as less than about 4,000 ppb, such as less than about 3,500 ppb, such as less than about 3,000 ppb, such as less than about 2,500 ppb, such as less than about 2,000 ppb, such as less than about 1,500 ppb, such as less than about 1,000 ppb, such as less than about 900 ppb, such as less than about 800 ppb, such as less than about 700 ppb, such as less than about 600 ppb, such as less than about 500 ppb, such as even less than about 400 ppb. The concentration of one or more fluroxypyr herbicides added to the body of water is generally greater than about 5 ppb, such as greater than about 10 ppb, such as greater than about 20 ppb, such as greater than about 50 ppb, such as greater than about 100 ppb. In fact, it was discovered that the fluroxypyr herbicide in accordance with the present disclosure is capable of controlling Eurasian watermilfoil in bodies of water at concentrations typically lower than that needed when using 2,4-D.

The aquatic herbicide composition can be applied to a body of water by applying the composition over the surface of the water or by applying the composition below the surface of the water. In one embodiment, for instance, the aquatic herbicide composition can be applied as a spray. When applied as a spray, for instance, the aquatic herbicide composition can be applied directly to floating and/or emergent aquatic weeds which may have some advantages in certain embodiments.

In one embodiment, the aquatic herbicide composition can be sprayed and applied directly to plant foliage. In this embodiment, the aquatic herbicide composition can be applied to a body of water such that one or more fluroxypyr herbicides are applied to the water in an amount less than about 50 oz. per acre, such as less than 40 oz. per acre, such as less than 30 oz. per acre, such as less than 25 oz. per acre, such as less than 20 oz. per acre, such as less than 15 oz. per acre, such as less than 10 oz. per acre, such as less than 8 oz. per acre, such as less than 5 oz. per acre. The one or more fluroxypyr herbicides are generally applied in an amount greater than 0.001 oz. per acre, such as greater than about 0.01 oz. per acre, such as greater than about 0.5 oz. per acre.

Alternatively, the aquatic herbicide composition can be applied below the surface of the water. In one embodiment, for instance, the aquatic herbicide composition can be applied to a body of water by being pumped into the body of water below the surface.

The present disclosure may be better understood with reference to the following examples.

### EXAMPLES

### Example 1: Evaluation of Fluroxypyr Herbicide on Eurasian Watermilfoil

The following tests were conducted to determine the efficacy of a fluroxypyr herbicide on Eurasian watermilfoil under mesocosm conditions. In this example, Eurasian watermilfoil were treated with a fluroxypyr herbicide and were treated with a 2,4-D herbicide for purposes of comparison. The fluroxypyr herbicide used was a meptyl ester of fluroxypyr.

Materials and Methods: Eurasian watermilfoil was obtained from cultures. Two apical tips approximately 15 cm long were planted into each of 108, plastic containers. The containers were filled with Black Kow potting soil and amended with 2 g/L Osmocote fertilizer 19-6-12. Four containers of potted Eurasian watermilfoil were placed into each of 27 mesocosm tanks. Mesocosm tanks were filled to a volume of 276 L (48 cm depth) and plants allowed to grow approximately 2-3 weeks prior to herbicide treatments or until plants were at or near the water surface. Pre-treatment biomass was harvested from an extra mesocosm tank set up with potted Eurasian watermilfoil for this purpose. Biomass was harvested by collecting aboveground biomass of plants in the tank. Plant material were dried at 70 C for at least 48 h and weighed to assess biomass.

After pre-treatment data collection, concentrated liquid herbicides were applied as the formulations and rates outlined in Table 1. An untreated reference was also included for comparison purposes. All herbicide applications were made using a 24 h exposure and replicated 3 times. After the exposure time was reached, each mesocosm tank was drained and refilled with fresh water to remove any herbicide residue remaining in the water column.

TABLE 1
Herbicides and treatment rates for Eurasian
watermilfoil efficacy screening.

| | | Herbicide |
|---|---|---|
| Treatment | | Concentration |
| Number | Formulation | (μg/L) |
| 1 | Untreated Reference | 0 |
| 2 | 2,4-D (DMA 4-IVM) | 1500 |
| 3 | Fluroxypyr ester | 50 |
| 4 | Fluroxypyr ester | 100 |
| 5 | Fluroxypyr ester | 200 |
| 6 | Fluroxypyr ester | 400 |
| 7 | Fluroxypyr ester | 800 |
| 8 | Fluroxypyr ester | 1600 |
| 9 | Fluroxypyr ester | 3200 |

Each week, tanks were rated for percent control on a 0-100% scale (0%=no control; 100%=complete plant mortality). Four weeks after treatment (WAT), living plants were harvested, sorted to aboveground biomass, dried, and weighed for biomass determination. Differences between treatments were analyzed using an ANOVA test with means separated using a Fisher's Protected LSD test. Fluroxypyr data were fitted to an exponential decay regression model in order to estimate the EC₅₀ value for fluroxypyr use on Eurasian watermilfoil.

Results and Discussion: Eurasian watermilfoil biomass during the pretreatment harvest was 0.43 g/DW/tank and by 4 WAT biomass in the untreated reference tanks was 4.99±0.42 g/DW/tank, a 91% increase in biomass. The increase in biomass in untreated reference tanks indicates that plants were actively growing throughout the study and any declines can be attributed to the herbicide treatments. The fluroxypyr herbicide and 2,4-D were applied to the designated tanks as the concentrated liquid.

Control of Eurasian watermilfoil was 60-80% 1 WAT with all herbicide treatments with the exception of the fluroxypyr herbicide applied at 50 ug/L (Table 2). At 2 WAT all treatments resulted in 100% control with the exception of the fluroxypyr ester applied at 50 and 100 ug/L, though the 100 ug/L treatment resulted in 90% control during this time period. By the conclusion of the study all treatments resulted in 95-100% control of Eurasian watermilfoil except for the 50 ug/L treatment. By 4WAT, the fluroxypyr herbicide applied at 50 ug/L resulted in a 76% biomass reduction followed by 99% in tanks treated with 100 ug/L fluroxypyr; all other tanks had no viable plant tissues remaining.

TABLE 2
Visual control ratings of Eurasian watermilfoil following treatments
of fluroxypyr ester and 2,4-D (n = 4 for each treatment).

WAT

| Treatment (ug/L) | One | Two | Three | Four |
|---|---|---|---|---|
| Untreated Reference | 0 | 0 | 0 | 0 |
| 2,4-D 1500 | 70 | 100 | 100 | 100 |
| Fluroxypyr ester 50 | 30 | 60 | 50 | 45 |
| Fluroxypyr ester 100 | 60 | 90 | 90 | 95 |
| Fluroxypyr ester 200 | 60 | 100 | 100 | 100 |
| Fluroxypyr ester 400 | 70 | 100 | 100 | 100 |
| Fluroxypyr ester 800 | 70 | 100 | 100 | 100 |
| Fluroxypyr ester 1600 | 80 | 100 | 100 | 100 |
| Fluroxypyr ester 3200 | 80 | 100 | 100 | 100 |

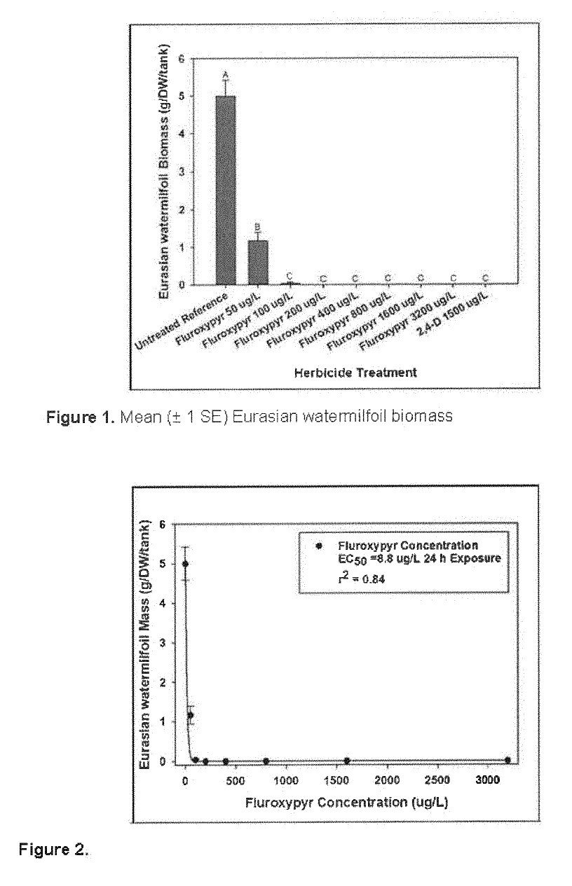

All herbicide treatments resulted in significant reductions in biomass when compared to untreated reference plants (FIG. 1). Although fluroxypyr applied at 50 ug/L was not as effective as the other treatments, it did result in a 76% decrease in biomass and could offer nuisance relief of Eurasian watermilfoil for at least 4 weeks if concentrations were maintained for 24 h. However, if a longer exposure time (48-72 h) is achieved, the 50 ug/L concentration may offer excellent Eurasian watermilfoil control.

The increased activity of fluroxypyr on Eurasian watermilfoil relative to 2,4-D is further supported when the EC₅₀ is estimated. The EC₅₀ for Eurasian watermilfoil treated with fluroxypyr in this study is estimated to be 8.8 ug/L (FIG. 2). Based on data from this study fluroxypyr is very effective at controlling Eurasian watermilfoil at concentrations as low as 50 ug/L.

### Example 2: Evaluation of Fluroxypyr Herbicide as a Foliar Application on Water Hyacinth

The following example was conducted to demonstrate that a fluroxypyr herbicide has activity on water hyacinth at select application rates.

Materials and Methods: Water hyacinth was obtained from field locations and cultured outdoors in a 300 gallon tank. Water in the culture tank was amended with 30 mg/L Miracle-Gro® fertilizer (14-8-16) every week to maintain plant growth. Aquashade® was added to the tank in sufficient concentration to darken the water in order to reduce algae growth

Once a sufficient density of water hyacinth had been achieved in the culture tank (plants had covered the water surface), 54-63 rosettes of similar size were harvested and divided so that six to seven rosettes (depending upon size) were placed into each of 9, 100 gallon treatment tanks. The treatment tanks were filled to a depth of 45 cm with water. Water in each treatment tank was amended and maintained in a similar fashion as the culture tank. Plants were allowed to grow approximately 2 weeks or until the water surface in each tank had been covered. Pre-treatment biomass (1 per tank) was harvested using a 0.1 m² PVC quadrat. The quadrat was pushed down over the plant mat in each tank and all biomass was harvested within the PVC frame. Biomass from each tank was rinsed, placed in a paper bag, and dried at 50 C to assess biomass.

After the growth period and pre-treatment harvest, plants were treated as a foliar spray using the product and rates outlined in Table 3. Treatments were applied using water as a carrier in a fine foliar spray and a total spray volume of 100 gal/acre. AB Brand Adjuvant (commercially available from Lonza, Inc.) was included in the herbicide solution at a rate of 0.25% v:v.

TABLE 3
Fluroxypyr treatment rates for the water hyacinth trial.

| Treatment | Rate (oz/acre) |
|---|---|
| Reference | 0 |
| Fluroxypyr meptyl ester | 8 |
| Fluroxypyr meptyl ester | 16 |

After treatment, each tank was rated on a scale from 0 (no control) to 100% (complete mortality) control every week for six weeks. At six weeks after treatment the 0.1 m² PVC quadrat was used to harvest 1 biomass sample from each tank if living biomass was present. Samples were rinsed, placed into labeled paper bags, and dried at 50 C to determine dry weight biomass. Differences between treatments were analyzed using ANOVA at a p≤0.05 significance level, and if a difference in treatments was detected means were then separated using a Fisher's Protected LSD test.

Results and Discussion: Pre-treatment biomass of water hyacinth was 146.9 g/DW/tank, and by the conclusion of the study, biomass in the untreated reference tanks had increased to 1485 g/DW/tank. The increase in biomass indicates that plants were actively growing throughout the study and any reductions in biomass observed can be attributed to the herbicide application.

TABLE 4
Mean percent control ratings (n = 3) of water hyacinth
following applications of fluroxypyr at select rates.

| | Weeks After Treatment | | | | | |
|---|---|---|---|---|---|---|
| Treatment | One | Two | Three | Four | Five | Six |
| Untreated Reference | 0 | 0 | 0 | 0 | 0 | 0 |
| Fluroxypyr meptyl ester 8 | 15 | 40 | 45 | 65 | 85 | 85 |
| oz/acre | | | | | | |
| Fluroxypyr meptyl ester 16 | 35 | 45 | 65 | 85 | 95 | 95 |
| oz/acre | | | | | | |

Control of water hyacinth was 15 and 35% respectively at 1 WAT for the 8 oz/acre and 16 oz/acre treatments (Table 4). Control remained below 70% for 3 weeks; though by 4 WAT the highest rate tested resulted in 85% control. At 6 WAT control of water hyacinth was 85 and 95% respectively for the 8 oz/acre and 16 oz/acre treatments. Water hyacinth growth was greatly reduced in the 8 oz/acre treatment and only a few small plants had begun to regrow in the 16 oz/acre treatment.

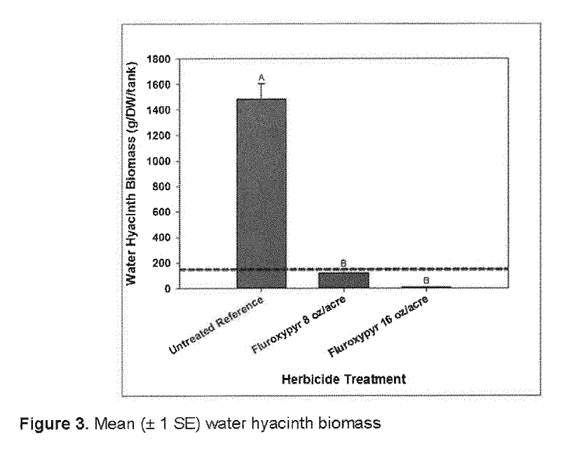

Water hyacinth biomass was reduced (p<0.01) by 90% when fluroxypyr was applied at a rate of 8 oz/acre (FIG. 3). Biomass reduction was 99% at 6 WAT when fluroxypyr was applied at 16 oz/acre. There was no difference in water hyacinth control between the two herbicide rates tested, though both rates resulted in less biomass when compared to untreated reference plants. Plants treated with fluroxypyr exhibited characteristic auxin symptoms, most notably, petiole elongation and epinastic twisting and bending. Plant death occurred by approximately 4 WAT in the 16 oz/acre treatment, and 5 to 6 WAT in the 8 oz/acre treatment.

### Example 3: Evaluation of a Fluroxypyr Potassium Salt Formulation on Eurasian Watermilfoil in Small Scale Aquaria

The following example determines the efficacy of a potassium salt formulation of fluroxypyr on Eurasian watermilfoil in small scale aquaria, in comparison to the fluroxypyr ester formulation.

Materials and Methods: Eurasian watermilfoil was obtained from cultures. Two apical tips approximately 10 cm long were planted into each of 96, plastic containers (473 mL). The containers were filled with potting soil and amended with 2 g/L/soil Osmocote® fertilizer 19-6-12. A layer of sand was placed on top of the sediment in each container to prevent sediment re-suspension in the aquaria. Four containers of potted Eurasian watermilfoil were placed into each of 24 aquaria. Each aquaria was filled to a volume of 45 L and plants allowed to grow approximately 2-3 weeks prior to herbicide treatments or until plants were at or near the water surface. Pre-treatment biomass was harvested from extra aquaria set up with pots for this purpose. Biomass was harvested by cutting aboveground biomass of plants at the soil surface in the three pretreatment aquaria. Harvested plant material was placed into individually labeled paper bags, dried in a force air oven at 50 C for at least 48 h, and then weighed to assess biomass.

After pre-treatment data collection, concentrated liquid herbicides were applied as the formulations and rates outlined in Table 5. In the formulations below, the fluroxypyr was present in an amount of 15% by weight, while the surfactant was present in an amount of 10% by weight. The remainder of the formulations contained distilled water. An untreated reference was also included for comparison purposes. All herbicide applications were made using a 24 h exposure and replicated 3 times. After the exposure time was reached, each aquarium was drained and refilled with fresh water to remove any herbicide residues remaining in the water column.

TABLE 5
Fluroxypyr formulations and treatment rates for Eurasian
watermilfoil efficacy screening in aquaria.

| | Herbicide |
|---|---|
| | Concentration |
| Formulation | (ug/L) |
| Untreated Reference | 0 |
| Fluroxypyr (methylheptyl ester) | 50, 200, 400 |
| Fluroxypyr (Potassium Salt) | 50, 200, 400 |
| Tristyrylphenol EO 60 | |

Each week, aquaria were rated for percent control on a 0-100% scale (0%=no control; 100% complete plant mortality). Four weeks after treatment (WAT), all living plants were harvested at the sediment surface, sorted to aboveground biomass (if any), dried in a forced air oven at 50 C for at least 48 h, and weighed for biomass determination. Differences between treatments were analyzed using ANOVA and means separated using a Fisher's Protected LSD test at a p≤0.05 significance level.

Results and Discussion: Eurasian watermilfoil was actively growing throughout the study as indicated by the increase (67%) biomass between the pretreatment samples and the post treatment untreated reference biomass. At 1 WAT, control ranged from 20% to 60% depending upon the concentration of fluroxypyr in the water. By 2 WAT, plants treated with 400 ug/L of fluroxypyr were controlled 80% to 90% regardless of formulation. At the conclusion of the study (4 WAT), 200 ug/L of fluroxypyr provided 60% to 90% control; however the ester formulation provided greater control than the potassium salt formulation.

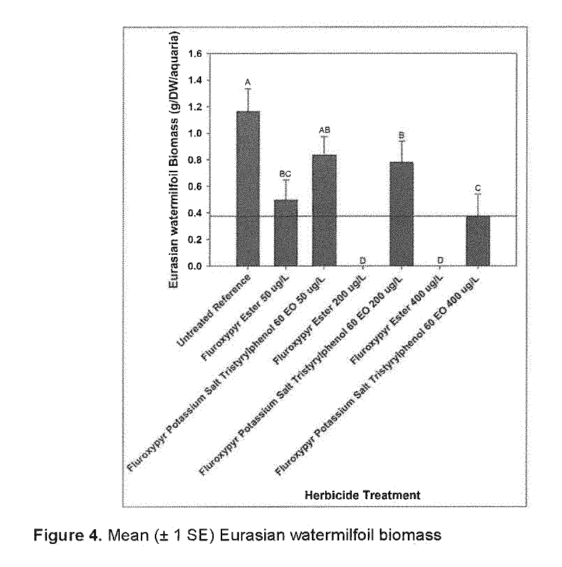

Eurasian watermilfoil biomass was reduced by all fluroxypyr treatments When compared to the untreated reference plants (FIG. 4). Fluroxypyr ester was more efficacious than the potassium salt formulation when applied at 200 and 400 ug/L. Biomass reduction was 100% when the ester formulation was applied at 200 and 400 ug/L. Conversely, biomass reduction was 33% and 70% respectively when the potassium salt was applied at 200 and 400 ug/L.

### Example 4: Evaluation of Fluroxypyr Potassium Salt Formulations on Eurasian Watermilfoil Under Mesocosm Conditions

The following example demonstrates the efficacy of four potassium salt formulations of fluroxypyr on Eurasian watermilfoil under mesocosm conditions, and compare those formulations against the fluroxypyrester formulation.

Eurasian watermilfoil was obtained from cultures. Two apical tips approximately 15 cm long were planted into each of 204, plastic containers (940 mL). The containers were filled with potting soil and amended with 2 g/L/soil Osmocote® fertilizer 19-6-12. Four containers of potted Eurasian watermilfoil were placed into each of 51 mesocosm tanks. Tanks were filled to a volume of 257 L and plants allowed to grow approximately 2-3 weeks prior to herbicide treatments, or until plants were at or near the water surface. Pre-treatment biomass was harvested from three tanks set up with pots for this purpose. Biomass was harvested by collecting aboveground biomass of plants from all of the pots in each of the pretreatment tanks. Plant material was placed into individually labeled paper bags, dried in a force air oven at 50 C for at least 48 h, and then weighed to assess biomass,

After pre-treatment data collection, liquid herbicides were applied as a concentrated aqueous formulation using the rates and products outlined in Table 6. In the formulations below, the fluroxypyr was present in the compositions in an amount of 15% by weight. The different surfactants were added in amounts of 10% by weight. The remainder of each formulation was distilled water. An untreated reference was also included for comparison purposes. All herbicide applications were made using a 24 h exposure and replicated 3 times. After the exposure time was reached, each tank was drained and refilled with fresh water to remove any herbicide residues remaining in the water column.

TABLE 6
Fluroxypyr formulations and treatment rates for Eurasian
watermilfoil efficacy screenings in mesocosms.

| | Herbicide |
|---|---|
| | Concentration |
| Formulation | (ug/L) |
| Untreated Reference | 0 |
| Fluroxypyr (1-methylheptyl | 50, 200, 400 |
| ester) | |
| Fluroxypyr (Potassium Salt) - | 50, 200, 400 |
| Castor Oil EO 40 | |
| Fluroxypyr (Potassium Salt) - | 50, 200, 400 |
| Tridecyl Alcohol EO 50 | |
| Fluroxypyr (Potassium Salt) - | 50, 200, 400 |
| Tristyrylphenol EO 60 | |
| Fluroxypyr (Potassium Salt) - | 50, 200, 400 |
| Fatty Acid 30 EO | |

Four weeks after treatment (WAT), living plants were, harvested, sorted to aboveground biomass (if any), dried in a forced air oven at 50 C for at least 48 h, and weighed for biomass determination. Differences between treatments were analyzed using ANOVA with treatment means separated using a Fisher's Protected LSD test at a p≤0.05 significance level.

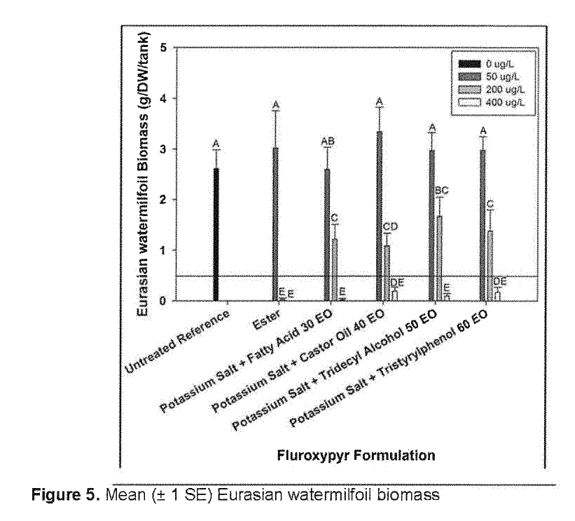

Results and Discussion: Eurasian watermilfoil was actively growing throughout the study as indicated by the increase in biomass (80%) between the pretreatment samples and the untreated reference plants at 4 WAT (FIG. 5). Therefore, any reductions in biomass were due to the herbicide treatments and not natural senescence. The ester formulation was more effective on Eurasian watermilfoil when applied at 200 ug/L when compared to the potassium salt formulations. The ester formulation provided 98% biomass reduction whereas the potassium salt formulations provided 38% to 58% biomass reduction at the same fluroxypyr concentration.

When the concentration was increased to 400 ug/L there were no differences in efficacy between any of the fluroxypyr formulations tested (FIG. 5). All formulations, resulted in 92% to 100% biomass reduction.

The ester formulation was more efficacious on Eurasian watermilfoil at concentrations below 400 ug/L. The ester formulations are more lipophilic which increases the rate of absorption into plants.

### Example 5: Comparison of Fluroxypyr Ester and Four Fluroxypyr Potassium Salt Formulations as a Foliar Application on Water Hyacinth

The following example determines the efficacy of a meptyl ester fluroxypyr formulation on water hyacinth and compares the efficacy of the fluroxypyr ester to four new potassium salt formulations of fluroxypyr.

Materials and Methods: Water hyacinth was obtained from field locations in Mississippi and cultured in a 300 gallon tank outdoors. Water in the culture tank was amended with 30 mg/L Miracle-Gro fertilizer (14-8-16) every week to maintain plant growth. Once a sufficient density of water hyacinth had been achieved in the culture tank, rosettes of similar size were harvested and divided so that six to seven rosettes were placed into each of 33, 100 gallon treatment tanks. The treatment tanks were filled to a depth of 45 cm with water. Water was amended with 30 mg/L of Miracle-Gro fertilizer to maintain plant growth. Plants were allowed to grow until the water surface in each tank had been covered by water hyacinth.

After the growth period plants were treated as a foliar spray based on the formulations and rates in Table 7. The treatments contained the fluroxypyr herbicide in an amount of 15% by weight. Each surfactant was added in an amount of 10% by weight. The remainder of the formulation was distilled water. Treatments were applied using water as a carrier in a fine foliar spray at a total spray volume of 100 gal/acre using a CO₂ pressurized backpack sprayer and single nozzle boom. AB Brand Adjuvant was included in the herbicide solution at a rate of 0.25% v:v.

TABLE 7
Fluroxypyr formulations and treatment
rates for the water hyacinth trial.

| | Application Rate |
|---|---|
| Treatment | oz/acre¹ |
| Untreated Reference | 0 |
| Fluroxypyr Ester | 8, 16 |
| Potassium Salt Fluroxypyr | 10, 20 |
| Fatty Acid 30 EO | |
| Potassium Salt Fluroxypyr | 10, 20 |
| Castor Oil 40 EO | |
| Potassium Salt Fluroxypyr | 10, 20 |
| Tridecyl Alcohol 50 EO | |
| Potassium Salt Fluroxypyr | 10, 20 |
| Tristyrylphenol 60 EO | |

¹The application rates were adjusted so that the same amount of active ingredient was being applied in each treatment.

After treatment, each tank was rated for percent control from 0 to 100% control every week for four weeks. At four weeks after treatment (WAT) a 0.1 m² PVC quadrat was used to harvest 1 biomass sample from each tank if living biomass was present. Biomass samples were placed into labeled paper bags, dried in a forced air oven at 50 C for five days, and then weighed to determine dry weight biomass (g/DW/m²). Differences between treatments were analyzed using ANOVA and means separated using a Fisher's Protected LSD test. All analyses were conducted a p≤0.05 significance level.

Results and Discussion: Water hyacinth was actively growing throughout the study as the initial six to seven rosettes reproduced and expanded to cover the water surface. By 4 WAT the untreated reference biomass was 548.02±27.21 g/m². Response of water hyacinth to the herbicide treatments was typical for injury symptoms produced by an auxin herbicide. At 1 WAT plants displayed epinastic twisting and bending of the petioles and mild chlorosis. Percent control at this time was only 10 to 30% (Table 8). At 2 WAT plants treated with the Tridecyl Alcohol 50 EO formulation had a control rating of 60%. By 4 WAT all treatments controlled water hyacinth by ≥70% with the exception of the Fatty Acid 30 EO and Castor Oil 40 EO formulations applied at 10 oz/per acre where control was only 40 and 50% respectively.

TABLE 8
Mean percent control ratings of water hyacinth following foliar
applications of different formulations of fluroxypyr herbicide.

| | Rate | | | | |
|---|---|---|---|---|---|
| Treatment | (oz/acre) | One | Two | Three | Four |
| Untreated Reference | 0 | 0 | 0 | 0 | 0 |
| Fluroxypyr Ester | 8 | 20 | 25 | 55 | 75 |
| Fluroxypyr Ester | 16 | 20 | 45 | 85 | 95 |
| Potassium Salt Fluroxypyr | 10 | 10 | 10 | 30 | 40 |
| Fatty Acid 30 EO | | | | | |
| Potassium Salt Fluroxypyr | 20 | 20 | 30 | 70 | 80 |
| Fatty Acid 30 EO | | | | | |
| Potassium Salt Fluroxypyr | 10 | 15 | 20 | 45 | 50 |
| Castor Oil 40 EO | | | | | |
| Potassium Salt Fluroxypyr | 20 | 25 | 25 | 60 | 70 |
| Castor Oil 40 EO | | | | | |
| Potassium Salt Fluroxypyr | 10 | 25 | 30 | 70 | 85 |
| Tridecyl Alcohol 50 EO | | | | | |
| Potassium Salt Fluroxypyr | 20 | 30 | 60 | 90 | 95 |
| Tridecyl Alcohol 50 EO | | | | | |
| Potassium Salt Fluroxypyr | 10 | 20 | 30 | 75 | 90 |
| Tristyrylphenol 60 EO | | | | | |
| Potassium Salt Fluroxypyr | 20 | 20 | 30 | 70 | 90 |
| Tristyrylphenol 60 EO | | | | | |

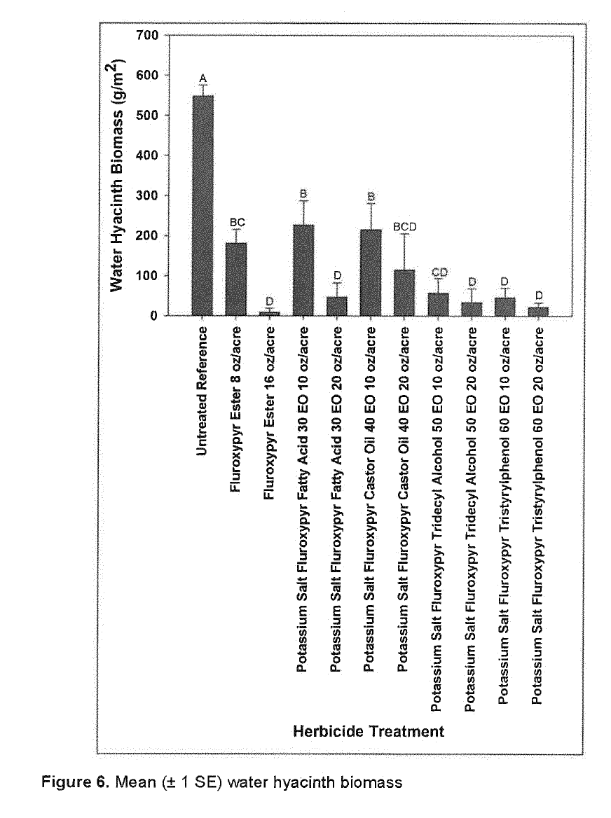

All fluroxypyr formulations reduced water hyacinth biomass 4 WAT when compared to untreated reference plants (FIG. 6). However, the Ester formulation applied at 8 oz/acre, Fatty Acid 30 EO formulation applied at 10 oz/acre, and the Castor Oil 40 EO formulation applied at 10 oz/acre were not as efficacious as the other fluroxypyr treatments. The Tridecyl Alcohol 50 EO and Tristyrylphenol 60 EO formulations applied at 10 oz/acre were more efficacious than the other two potassium salt formulations applied at the same rate, and provided similar control as the 20 oz/acre rate. The ester formulation in this study was comparable to the potassium salt formulations.

### Example 6: Evaluation of Fluroxypyr Ester Herbicide on Select Native Aquatic Plants in Small Scale Aquaria

The following example determines the dose response of sago pondweed and elodea to submersed applications of a fluroxypyr ester.

Materials and Methods: The study was conducted in an indoor aquaria facility. Elodea (Elodea canadensis) was obtained from cultures. Two apical tips approximately 10 cm long were planted into each of 48, plastic containers (16 oz. plastic cups). The containers were filled with potting soil and amended with 2 g/L Osmocote® fertilizer 19-6-12. A layer of sand was placed on top of the sediment in each container to prevent sediment re-suspension in the aquaria. Two containers of potted elodea were placed into each of 24 aquaria measuring 11.5 in×11.5 in×24 in. Additionally, sago pondweed (Stuckenia pectinata) tubers were obtained. The tubers were floated in shallow containers filled with water until new sprouts began to grow.

Once sprouted, two tubers were planted into 16 oz containers in a similar fashion as elodea. Two containers of potted sago pondweed were placed into each of the 24 aquaria, so that each aquarium had 4 potted plants (2 pots of each species). Each aquarium was filled to a volume of 45 L and plants allowed to grow approximately 3-4 weeks prior to herbicide treatments or until plants were at or near the water surface. Supplemental lighting was provided using Agrobrite growth lamps on a 12:12 light:dark cycle. After the plants reached the desired level of growth, a liquid formulation of fluroxypyr ester was applied as a concentrated aqueous solution at the concentrations outlined in Table 9. An untreated reference was also included for comparison purposes. All herbicide applications were made using a static exposure and replicated 3 times. The static exposure represents a worst case scenario in that the herbicide did not undergo dilution or dissipation and the plants were exposed to the herbicide for extended periods of time. Water was added to the aquaria as needed to maintain the desired 45 L volume of water.

TABLE 9
Fluroxypyr formulations and treatment rates for the
native plant selectivity screening in aquaria.

| | Herbicide |
|---|---|
| Formulation | Concentration (ug/L) |
| Untreated Reference | 0 |
| Fluroxypyr | 50, 100, 200, |
| (methylheptyl ester) | 400, 800, 1600, |
| 15% wt | 3200 |

At four weeks after treatment (WAT), plants were, harvested, sorted to aboveground biomass, dried in a forced air oven at 50 C for at least 48 h, and weighed for biomass determination (g/DW/aquaria). Differences between treatments were analyzed using an ANOVA, and if treatment differences were detected; means were separated using a Tukey's All-Pairwise comparison test. All analyses were conducted at a p≤0.05 significance level. Additionally, regression models were fit to elodea biomass data in order to estimate the EC₅₀ concentration under the current experimental design.

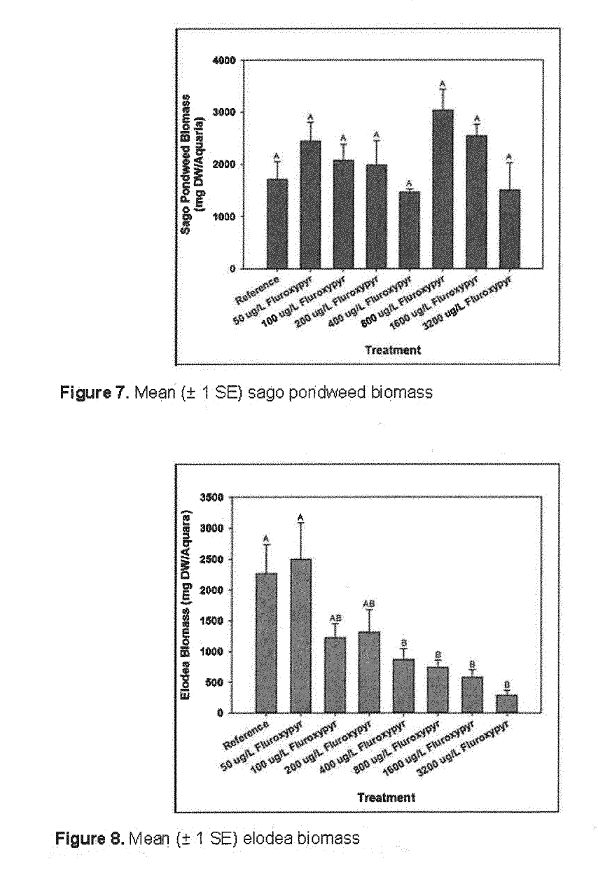

Results and Discussion: After four weeks of exposure to fluroxypyr, sago pondweed did not exhibit any adverse effects across the range of concentrations evaluated (FIG. 7). Biomass was similar among all treatments. Furthermore, there were no visible herbicide symptoms (i.e. epinastic bending and twisting) that are representative of auxin herbicide exposure throughout the study.

Unlike sago pondweed, elodea was somewhat less tolerant to fluroxypyr under the current experimental design especially at higher concentrations (FIG. 8). Elodea did exhibit epinastic twisting and bending within one WAT. These symptoms were transient in the lower concentration treatments. Elodea biomass at four WAT was similar between the untreated reference plants and plants exposed to 50, 100, and 200 ug/L fluroxypyr. Biomass was reduced (p<0.01) when fluroxypyr was applied at 400 ug/L or higher.

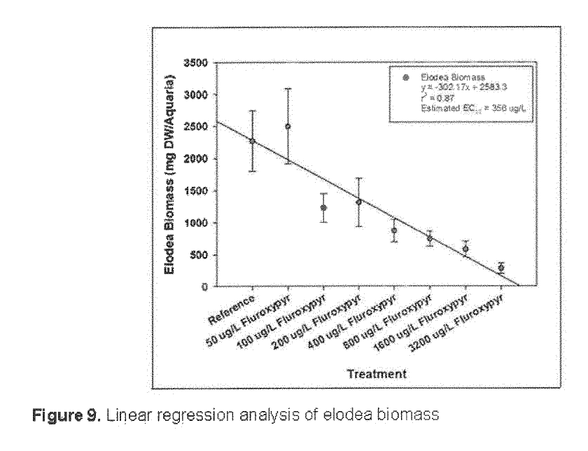

Although elodea did exhibit sensitivity to fluroxypyr in this study, it was due to the static exposure that the plants received. Long concentration and exposure times are rare under field conditions, but are necessary to test under experimental conditions as a worst case scenario. The EC₅₀ for elodea was estimated to be 356 ug/L of fluroxypyr as a static exposure (FIG. 9). The EC₅₀ of elodea is orders of magnitude higher than that estimated for Eurasian watermilfoil which was 8.8 ug/L of fluroxypyr using a 24 h exposure. These data suggest that though elodea was sensitive to fluroxypyr, under field conditions with reduced exposure times, there would likely be little impact to elodea when fluroxypyr is applied at concentrations that are lethal to Eurasian watermilfoil.

Data from the current study indicate that fluroxypyr, when applied at concentrations that are lethal to target plants, has the potential to be a selective herbicide for submersed native aquatic plants.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A method for controlling aquatic weeds comprising:
applying to a body of water an aquatic herbicide composition in a herbicidally effective amount sufficient to kill a submersed or floating aquatic weed, the aquatic herbicide comprising a fluroxypyr herbicide, the fluroxypyr herbicide comprising a fluroxypyr ester, a fluroxypyr salt, or mixtures thereof.

2. A method as defined in claim 1, wherein the aquatic herbicide comprises the fluroxypyr ester.

3. A method as defined in claim 1, wherein the aquatic herbicide comprises the fluroxypyr salt.

4. A method as defined in claim 3, wherein the fluroxypyr salt comprises a potassium salt.

5. A method as defined in claim 1, wherein the body of water is a lake, a pond, a reservoir, an irrigation canal, or a wetland.

6. A method as defined in claim 1, wherein the aquatic herbicide composition is applied to the body of water in an amount sufficient to kill a submersed aquatic weed.

7. A method as defined in claim 1, wherein the aquatic herbicide composition is applied to the body of water in an amount sufficient to kill a milfoil plant.

8. A method as defined in claim 1, wherein the aquatic herbicide composition is applied to the body of water in an amount sufficient to kill a water hyacinth plant.

9. A method as defined in claim 1, wherein the aquatic herbicide composition is applied to the body of water in a liquid form.

10. A method as defined in claim 1, wherein the herbicide composition is applied to the body of water in a dry form.

11. A method as defined in claim 1, wherein the aquatic herbicide composition further contains a surfactant.

12. A method as defined in claim 11, wherein the surfactant comprises an ethoxylated surfactant.

13. A method as defined in claim 11, wherein the surfactant comprises an ethoxylated castor oil, an ethoxylated tridecyl alcohol, an ethoxylated tristyryl phenol, an ethoxylated fatty acid, or mixtures thereof.

14. A method as defined in claim 1, wherein the aquatic herbicide composition is applied to the body of water such that the fluroxypyr herbicide is present in the water at a concentration of less than about 4000 ppb and in an amount greater than about 10 ppb.

15. A method as defined in claim 1, wherein the aquatic herbicide composition comprises an aqueous solution, the aqueous solution containing the fluroxypyr herbicide in an amount from about 10% to about 70% by weight.

16. A method as defined in claim 1, wherein the fluroxypyr herbicide is the only herbicide contained in the aquatic herbicide composition.

17. A method as defined in claim 1, wherein the aquatic herbicide contains the fluroxypyr ester, the fluroxypyr ester comprising a meptyl ester or a butomeptyl ester.

18. A method as defined in claim 1, wherein the body of water comprises a pond or lake and wherein the aquatic herbicide composition is applied to the body of water in an amount sufficient to kill Eurasian watermilfoil that is present in the body of water.

19. A method as defined in claim 1, wherein the aquatic herbicide composition is applied to the body of water by spraying.

20. A method as defined in claim 1, wherein the aquatic herbicide composition is applied to the body of water by being pumped into the body of water below a surface of the water.

21. A method as defined in claim 1, wherein the aquatic herbicide composition is applied to the body of water such that the fluroxypyr herbicide is applied to plant foliage in an amount less than about 30 oz. per acre and in an amount greater than about 0.5 oz. per acre.
